(19) United States
(12) Patent Application Publication
(10) Pub. No.: US 2019/0029099 A1
(43) Pub. Date: Jan. 24, 2019

(54) LED LAMP

(71) Applicant: General Electric Company, Schenectady, NY (US)

(72) Inventors: Zhu MAO, Shanghai (CN); Min FANG, Shanghai (CN); Qi LONG, Shanghai (CN); Fanbin WANG, Shanghai (CN); Shuyi QIN, Shanghai (CN)

(21) Appl. No.: 16/031,560

(22) Filed: Jul. 10, 2018

(30) Foreign Application Priority Data
Jul. 21, 2017 (CN) 201710599645.5

(51) Int. Cl. H05B 41/288; F21V 23/00; H05B 33/08; H05B 41/38; H05B 35/00

(52) U.S. Cl. CPC H05B 41/2885; F21V 23/006; H05B 33/0809; F21Y 2115/10; H05B 41/38; H05B 35/00; H05B 33/0887

(57) ABSTRACT

The present invention discloses a light-emitting diode lamp for connecting to an external current source. The LED lamp comprises: a lighting source comprising a plurality of LEDs; a power control module for connecting in parallel to the external current source; and a driver unit connected between the power control module and the lighting source, wherein the power control module is configured to transform a source voltage of the external current source to a desired load voltage based on output power requirement of the plurality of LEDs; and the driver unit is configured to rectify the desired load voltage and output a driving voltage to drive the plurality of LEDs. Without the need to modify a lamp base of a conventional High Intensity Discharge lamp, the LED lamp of the present invention can be directly used to replace the HID lamp. Moreover, the power control module of the present invention ensures that LED lamps of different power have consistent shapes and dimensions, thus enhancing the versatility of components of the LED lamp and reducing the production costs.

### TECHNICAL FIELD

The present invention relates to a light-emitting diode (LED) lamp, and in particular, to an LED modified lamp used for a High Intensity Discharge (HID) ballast.

### BACKGROUND ART

HID lamps are arc lamps that form a high voltage between electrodes of a transparent fused silica glass tube filled with inert gas or halide salt to activate the inert gas to discharge, and then generate light. A stable operation of the HID lamp is implemented by necessarily using a ballast. The ballast is used to provide a high voltage of up to several kilovolts so as to break down and ionize the internal inert gas. Therefore, the HID ballast is usually integrated inside a lamp base of the HID lamp.

An LED lamp is a new product developed in recent years, of which a core device is a solid-state semiconductor device that can convert electric energy into visible light. The LED lamp has such advantages as energy saving and environmental protection, long service life, high brightness, and no strobe; and can more effectively generate light in application as compared with the HID lamp. Therefore, the LED lamp gradually replaces the conventional HID lamp. As described above, the HID lamp ballast is usually integrated inside the HID lamp base. When the LED lamp is used to replace the HID lamp, it needs to be connected to the HID lamp base before use. Therefore, it is required to design an LED lamp that can operate in cooperation with the HID ballast. Furthermore, LED lamps of different power are required in an actual application. In the existing solution, different capacitors are applied on a power control board of the LED lamp to implement power adjustment of the LED lamp. However, this solution has the following problems: On one hand, limited space of the LED lamp results in more limited space available for the power control board, thus restricting a selection range of capacitors; on the other hand, a capacitor with a particular capacitance value is only applied to an LED lamp of particular power, and when the LED lamp of the particular power is not produced any longer, the corresponding capacitors turn into surplus raw materials, thus failing to achieve effective utilization of the resources.

Therefore, it is necessary to provide a modified LED lamp to solve at least one of the foregoing problems.

### SUMMARY

One aspect of the present invention provides an LED lamp for connecting to an external current source (10). The LED lamp comprises: a lighting source (11) comprising a plurality of LEDs; a power control module (31) for connecting in parallel to the external current source (10); and a driver unit (32) connected between the power control module (31) and the lighting source (11), wherein the power control module (31) is configured to transform a source voltage of the external current source (10) to a desired load voltage based on output power requirement of the plurality of LEDs; and the driver unit (32) is configured to rectify the desired load voltage and output a driving voltage to drive the plurality of LEDs.

### BRIEF DESCRIPTION OF THE DRAWINGS

These and other features, aspects and advantages of the present invention will become better understood when the following detailed description is read with reference to the accompanying drawings, in which like reference numerals are used throughout the drawings to refer to like parts, where:

FIG. 1 is a schematic block diagram of an LED lamp according to a specific implementation of the present invention;

FIG. 2 is a schematic diagram of the LED lamp shown in FIG. 1 and including a power control module in a specific implementation;

FIG. 3 shows waveforms of a source voltage and a desired load voltage obtained after leading-edge phase cutting; and

FIG. 4 shows waveforms of a source voltage and a desired load voltage obtained after trailing-edge phase cutting.

### PREFERRED EMBODIMENTS

The specific embodiments of the present invention will be described in detail below with reference to the accompanying drawings in order to facilitate those skilled in the art to fully understand the subject matter claimed by the present invention. In the following detailed description of these specific embodiments, the present specification does not describe in detail any of the known functions or configurations, to avoid unnecessary details that may affect the disclosure of the present invention.

Unless otherwise defined, the technical and scientific terms used in the claims and the specification are as they are usually understood by those skilled in the art to which the present invention pertains. “First”, “second” and similar words used in the specification and the claims do not denote any order, quantity or importance, but are merely intended to distinguish between different constituents. The terms “one”, “a” and similar words are not meant to be limiting, but rather denote the presence of at least one. “Comprising”, “consisting of” and similar words mean that the elements or articles appearing before “comprising” or “consisting of” include the elements or articles and their equivalent elements appearing behind “comprising” or “consisting of”, not excluding any other elements or articles. “Connected”, “coupled” and similar words are not restricted to physical or mechanical connections, but may also include electrical connections, whether direct or indirect.

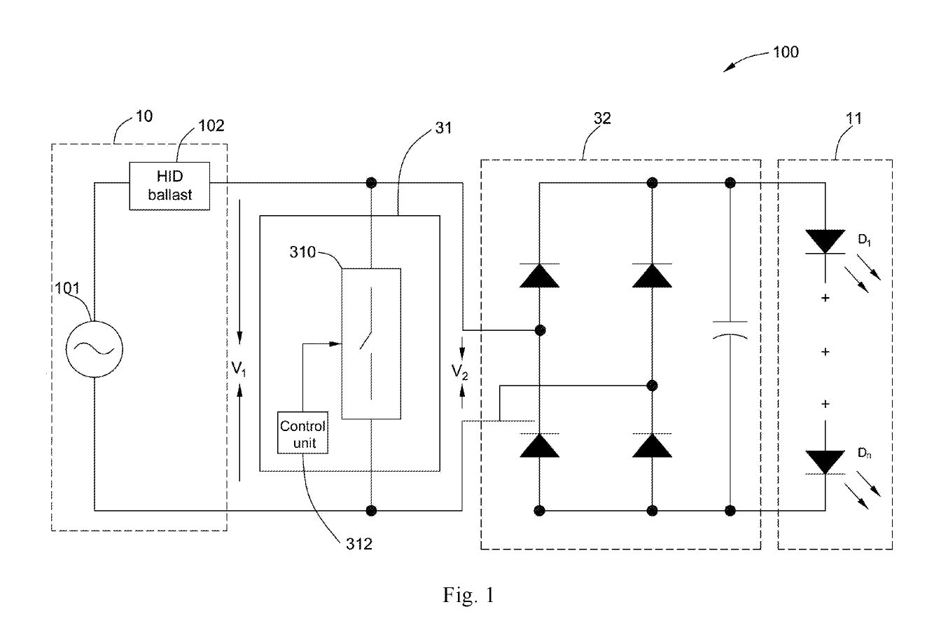

FIG. 1 is a schematic block diagram of an LED lamp 100 according to a specific implementation of the present invention. The LED lamp 100 may be, for example, an LED lamp used to replace an HID lamp. The HID lamp includes a light-emitting part and a lamp base. Because the light-emitting part requires a high voltage for stable operation, a ballast is accordingly integrated inside the lamp base thereof. The LED lamp 100 of the present invention can be directly applied to the lamp base of the conventional HID lamp, without the need to modify the lamp base of the conventional HID lamp. The LED lamp 100 is connected to an external current source 10 before use. The external current source 10 may be an actual constant-current source or an equivalent current source. For example, in this specific implementation, the external current source 10 may be formed by a main supply 101 and an HID ballast 102 connected in series with the main supply 101, but the present invention is not limited thereto. As shown in FIG.1, the LED lamp 100 includes a lighting source 11 including a plurality of LEDs; a power control module 31 for connecting in parallel to the external current source 10; and a driver unit 32 connected between the power control module 31 and the lighting source 11. The power control module 31 is configured to transform a source voltage V₁ of the external current source 10 to a desired load voltage V₂ based on output power requirement of the plurality of LEDs. An LED is a basic light-emitting unit of the LED lamp, and different LED lamps include different numbers and types of LEDs, so that different LEDs require different power. The power control module 31 aims to solve the technical problem of outputting corresponding power according to power requirements of the different LED lamps. The desired load voltage V₂ output by the power control module 31 is an alternating-current voltage, which cannot be directly used to drive the lighting source 11. Therefore, the driver unit 32 is required to rectify the desired load voltage V₂, to output a driving voltage to drive the lighting source 11.

As shown in FIG. 1, the power control module 31 includes a switching device 310 and a control unit 312, and the control unit 312 controls the switching device 310 to transform the source voltage V₁ to the desired load voltage V₂. Herein, the power control module 31 may have multiple topological structures and may be implemented in multiple manners. For example, the power control module 31 may be implemented as a single-phase controllable converter circuit, but the present invention is not limited thereto. In this implementation, the power control module 31 is a leading edge phase cutting device. In this leading edge phase cutting device, the control unit 312 is used to control an operation of the switching device 310, so as to implement phase cutting. That is, controlled by the control unit 312, the switching device 310 is alternately switched on or off, to cut a leading edge phase of the source voltage V₁, so as to obtain the desired load voltage V₂ and output it to the driver unit 32. In another alternative implementation, the power control module 31 may also be a trailing edge phase cutting device. In this trailing edge phase cutting device, the control unit 312 is used to control an operation of the switching device 310, so as to implement phase cutting. That is, controlled by the control unit 312, the switching device 310 is alternately switched on or off, to cut a trailing edge phase of the source voltage V₁, so as to obtain the desired load voltage V₂.

In this implementation, the switching device 310 is a controllable switch, and is connected in parallel to the external current source 10. The control unit 312 supplies a control signal to a control terminal of the switching device 310, to implement a control function for the switching device 310. Specifically, the switching device 310 is a voltage-controlled switch; and may include, but not limited to, a gate-turn-off thyristor (GTO), a metal-oxide-semiconductor field-effect transistor (MOSFET), an insulated-gate bipolar transistor (IGBT), and the like. The control unit 312 and the switching device 310 controlled by the control unit may be connected in multiple manners. For example, the control unit 312 may be independent of a main circuit including the switching device 310, and supplies the control signal to the switching device 310 only; or the control unit 312 may be connected to the main circuit in a particular manner.

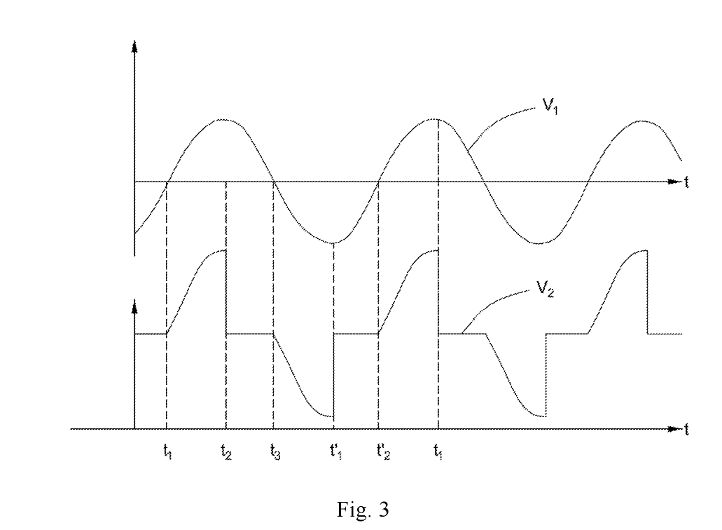

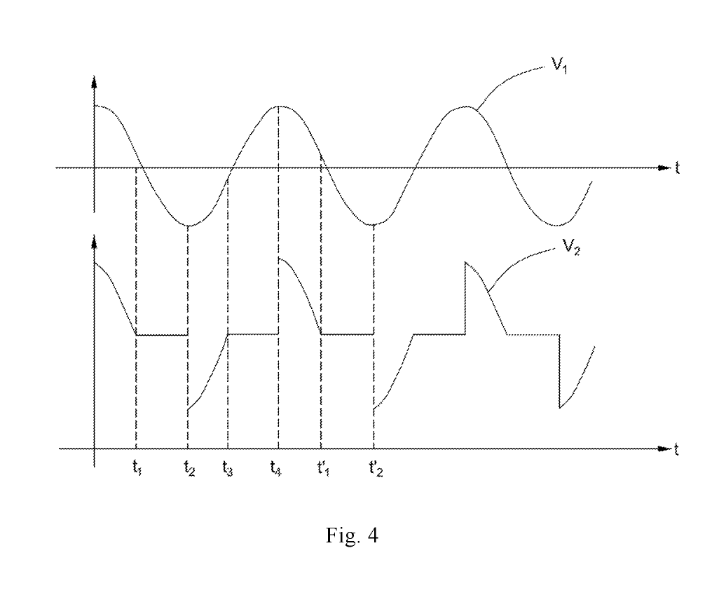

How the control unit 312 controls the switching device 310 to implement leading edge phase cutting is described in detail below with reference to FIG. 1 and FIG. 3. In FIG. 3, the upper half part is a waveform of the source voltage V₁ having not subjected to phase cutting, and the lower half part is a waveform of a voltage having subjected to phase cutting, namely, the desired load voltage V₂. When the control signal provided to the control terminal of the switching device 310 is not larger than a predefined level, this case is corresponding to a time period ti to tz in FIG. 3, the switching device 310 in FIG. 1 is switched off, and the part of the source voltage corresponding to the time interval t₁ to t₂ is provided to the driver unit 32 as the load voltage. When the control signal is larger than the predefined level, this case is corresponding to a time period t₂ to t₃ in FIG. 3, and the switching device 310 in FIG. 1 is switched on. It may be approximately considered that, the external current source 10 short-circuits through the switching device 310, and a supply path from the external current source 10 to the driver unit 32 is cut off. In this case, the load voltage approximates zero, and is corresponding to the waveform shown in the time period t₂ to t₃ in FIG. 3. Herein, the predefined level is a voltage threshold by which the voltage-controlled switch can be triggered to turn on, and a specific value of the voltage threshold is determined by the selected switching device 310. For different switching devices, the predefined level may be different. Accordingly, FIG. 4 shows a voltage waveform when the power control module 31 is a trailing edge phase cutting device. The upper half part is a waveform of the source voltage V₁ having not subjected to phase cutting, and the lower half part is a waveform of a voltage having subjected to phase cutting, namely, the desired load voltage V₂.

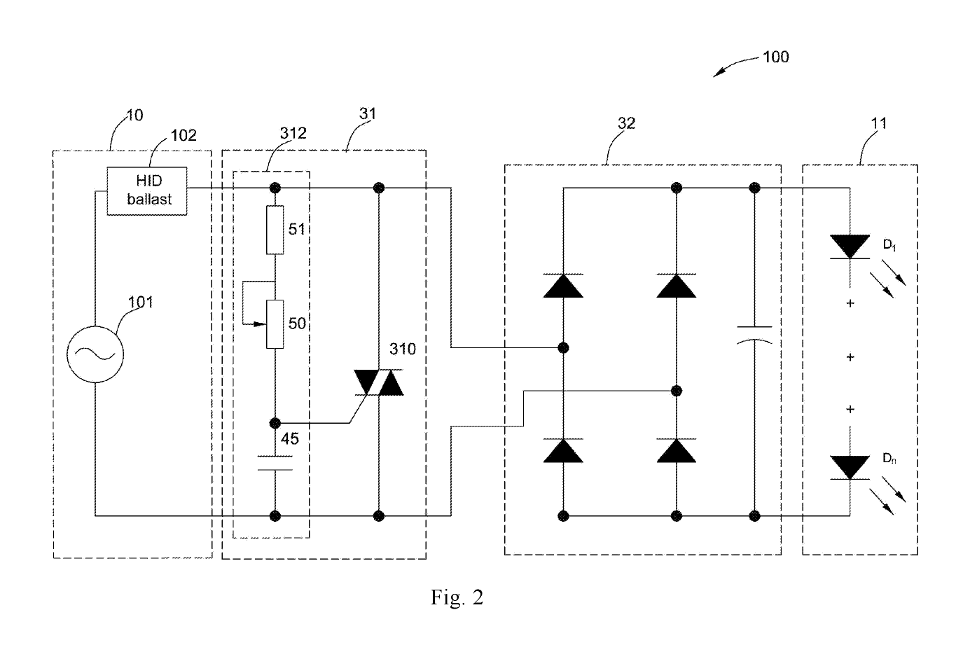

FIG. 2 is a schematic diagram of a power control module 31 in a specific implementation of the present invention. As shown in FIG. 2, the control unit 312 is connected in parallel to the switching device 310, and includes a variable resistor 50 and a capacitor 45 connected in series with the variable resistor 50. A series-connection point between the variable resistor 50 and the capacitor 45 is connected to a control terminal of the switching device 310. As such, a voltage of the capacitor 45 is used as the control signal to be transmitted to the control terminal of the switching device 310. The switching device 310 is a triode AC semiconductor switch (TRIAC) having two electrical terminals for connecting in parallel to the external current source 10, and the control terminal. In this implementation, a charging current of the capacitor 45 may be changed by adjusting the resistance of the variable resistor 50, so as to change charging time of the capacitor 45 charged to the predefined level. The change of the charging time may result in a change of a phase cut angle of the source voltage V₁, thus finally implementing a control over the desired load voltage V₂. Correspondingly, power absorbed by the lighting source 11 is controlled.

Further, as shown in FIG. 2, the control unit 312 may further include a protecting resistor 51 connected in series with the variable resistor 50. The control unit 312 is connected in parallel to the switching device 310, that is, the control unit 312 is connected in parallel to the external current source 10. When the variable resistor 50 is adjusted to zero due to misoperation, a risk such as overcurrent or even a short circuit may occur in the control unit 312. Thus, the protecting resistor 51 is set to effectively avoid this risk.

The LED lamp provided by the present invention can operate in cooperation with an HID ballast, without the need to modify a lamp base of a conventional HID lamp. Furthermore, when LED lamps of different power need to be produced, a conventional solution is using different capacitors to implement power adjustment of the LED lamps. However, this solution has the following problems: On one hand, limited space of the LED lamp results in a restriction on a selection range of capacitors; on the other hand, a capacitor with a particular capacitance value is only applied to an LED lamp of particular power, and when the LED lamp of the particular power is not produced any longer, the corresponding capacitors turn into surplus raw materials and are piled up in the warehouse, increasing the production costs. The power control module proposed in the present invention can solve this problem, to ensure that LED lamps of different power have consistent shapes and dimensions, thus enhancing the versatility of components of the LED lamp and reducing the production costs.

While the present invention has been described in detail with reference to specific embodiments thereof, it will be understood by those skilled in the art that many modifications and variations can be made in the present invention. It is, therefore, to be understood that the appended claims are intended to cover all such modifications and variations insofar as they are within the true spirit and scope of the invention.

1. An LED lamp for connecting to an external current source, comprising:
a lighting source including a plurality of LEDs;
a power control module for connecting in parallel to the external current source; and
a driver unit connected between the power control module and the lighting source, wherein
the power control module is configured to transform a source voltage of the external current source to a desired load voltage based on output power requirement of the plurality of LEDs; and
the driver unit is configured to rectify the desired load voltage and output a driving voltage to drive the plurality of LEDs.

2. The LED lamp of claim 1, wherein the external current source comprises a main supply and a high intensity discharge ballast connected in series with the main supply.

3. The LED lamp of claim 1, wherein the power control module comprises a switching device and a control unit, and the control unit controls the switching device to transform the source voltage to the desired load voltage.

4. The LED lamp of claim 3, wherein the power control module is a leading edge phase cutting device, and the control unit controls the switching device to cut a leading edge phase of the source voltage so as to obtain the desired load voltage.

5. The LED lamp of claim 4, wherein the switching device is a voltage-controlled switch and is connected in parallel to the external current source (10), and the control unit is configured to supply a control signal to a control terminal of the switching device; and
wherein when the control signal is larger than a predefined level, the switching device is switched on and the source voltage is cut off from the driver unit; when the control signal is not larger than the predefined level, the switching device is switched off and at least portion of the source voltage is provided to the driver unit as the load voltage.

6. The LED lamp of claim 5, wherein the control unit is connected in parallel to the switching device and comprises a variable resistor and a capacitor connected in series with the variable resistor, the control terminal of the switching device is connected to a connection point between the variable resistor and the capacitor, and a voltage of the capacitor is employed as the control signal.

7. The LED lamp of claim 6, wherein the switching device is a tri-electrode AC switch having two electrical terminals for connecting in parallel to the external current source and the control terminal.

8. The LED lamp of claim 6, wherein charging time of the capacitor charged to the predefined level is changed by adjusting a resistance of the variable resistor so as to modify a phase cut angle of the source voltage.

9. The LED lamp of claim 6, wherein the control unit further comprises a protecting resistor (51) connected in series with the variable resistor.

10. The LED lamp of claim 3, wherein the power control module is a trailing edge phase cutting device, and the control unit controls the switching device to cut a trailing edge phase of the source voltage so as to obtain the desired load voltage.
